(19) United States
(12) Patent Application Publication
(10) Pub. No.: US 2011/0268113 A1
(43) Pub. Date: Nov. 3, 2011

(54) Packet communication system, packet communication device, packet communication method, and computer-readable storage medium having packet communication program recorded therein

(75) Inventors: Jun Suzuki, Tokyo (JP); Masanori Takashima, Tokyo (JP)

(73) Assignee: NEC Corporation, Tokyo (JP)

(21) Appl. No.: 13/067,908

(22) Filed: Jul. 6, 2011

Related U.S. Application Data
(63) Continuation of application No. PCT/JP2010/057514, filed on Apr. 21, 2010.

(30) Foreign Application Priority Data
Apr. 24, 2009 (JP) JP2009-105790

(51) Int. Cl. H04L 12/56

(52) U.S. Cl. 370/389

(57) ABSTRACT

A packet communication system includes a virtual machine unit; an origin-of-movement communication unit; a movement-destination communication unit; and a storage unit which stores a packet destined for the virtual machine unit while the virtual machine unit moves from the origin-of-movement communication unit to the movement-destination communication unit and transfers the stored packet to the movement-destination communication unit.

This application is based upon and claims the benefit of priority from PCT Patent Application No. PCT/JP2010/057514, filed on Apr. 21, 2010, the disclosure of which is incorporated herein in its entirety by reference.

### TECHNICAL FIELD

The inventions are related to a packet communication system, a packet communication device, a packet communication method, and a computer-readable storage medium having a packet communication program recorded therein which are able to move a virtual machine executed in a device between devices.

### BACKGROUND ART

In this kind of packet communication system, such as when a computer of the system is maintained and checked, provision of services is continued by moving execution of services provided through a network from a computer to another computer. Examples of this packet communication system are described in Japanese laid-open patent application JP 2008-225546 (hereinafter Patent document 1), Japanese laid-open patent application 2008-165379 (hereinafter Patent document 2), and C. Clark, et al. “Live Migration of Virtual Machine” NSDI '05: 2^{nd} Symposium on Networked Systems Design & Implementation, May 2-4, 2005, pp. 273-286, (hereinafter Non-Patent document 1).

The virtual device configuration system described in Patent document 1 has structure for moving a virtual device to a different physical device in a virtualized environment.

The storage system described in Patent document 2 performs data movement to migration-destination storage while stopping access to origin-of-migration storage, when data migration between a plurality of storage devices is performed. The storage system switches a destination of a host into the migration-destination storage and restarts access, after movement of data is completed.

Further, the packet communication system described in Non-Patent document 1 has structure for moving services from an origin-of-movement host to a movement-destination host.

Referring to drawings, the packet communication system described in Non-Patent document 1 is described below.

FIG. 8 is a block diagram which illustrates the configuration of the packet communication system related to the invention, which is described in Non-Patent document 1. With reference to FIG. 8, the packet communication system related to the invention is composed of an origin-of-movement host (origin-of-movement communication device) 9, a movement-destination host (movement-destination communication device) 10, a network-shared storage device 4, a network switch A1, and an outside network A2.

The origin-of-movement host 9 provides services until the services are moved. The movement-destination host 10 is a movement-destination which takes over the services after the services are moved. Meanwhile, the movement of the services (virtual machine) is to hand over the services executed in the origin-of-movement host to the movement-destination host and to make a state in which the same services as executed in the origin-of-movement host can be executed in the movement-destination host. At that time, the services which are executed in the origin-of-movement host are stopped.

The network-shared storage device 4 is a shared storage device of the origin-of-movement host 9 and the movement-destination host 10, and provides a function of a secondary storage device for a virtual machine 11 before movement of the services and a virtual machine 21 after movement thereof. The network switch A1 connects the origin-of-movement host 9, the movement-destination host 10, and the network-shared storage device 4. The network switch A1 is connected to the outside network A2.

The origin-of-movement host 9 includes the virtual machine 11, a virtual machine monitor 91, and computer hardware 92.

The computer hardware 92 is composed of a computing CPU (Central Processing Unit) 131, a memory 132, and a network interface 921 which connects the origin-of-movement host 9 to the network switch A1.

The virtual machine 11 includes an operating system and an application software, and provides the services. The virtual machine 11 moves to the movement-destination host 10 when the services provided by a computer are transferred from the origin-of-movement host 9 to the movement-destination host 10.

The virtual machine monitor 91 controls the access of the virtual machine 11 to the computer hardware 92 and transmits information on the virtual machine 11 when the virtual machine 11 moves to the movement-destination host 10. This virtual machine monitor 91 is composed of a movement control unit 911, a transfer buffer 122, a dirty-memory detecting unit 121, and a HW (Hardware) access control unit 124.

The transfer buffer 122 is arranged on the memory 132 as HW, and stores information on a dirty memory to be transmitted to the movement-destination host 10. The dirty memory is data which the virtual machine 11 writes in the memory 132 while data of the virtual machine 11 moves. In other words, it shows the difference between the data of the moved virtual machine 11 and the data updated during movement of the virtual machine 11. The dirty-memory detecting unit 121 detects dirty memory which is generated during movement of the virtual machine 11 and writes the detected dirty memory in the transfer buffer 122, by storing data (dirty memory) newly written in the memory 132 during movement of the virtual machine 11. The HW access control unit 124 performs control for access to the computer hardware 92 of the virtual machine 11. Meanwhile, operations of movement control unit 911 are described below.

The movement-destination host 10 is composed of the virtual machine 21, a virtual machine monitor 101, and computer hardware 102.

The configuration of the computer hardware 102 is similar to that of the computer hardware 92 included in the origin-of-movement host 9. The CPU 131, the memory 132, and the network interface 921 correspond to a CPU 231, a memory 232, and a network interface 1021, respectively.

The virtual machine 21 moves from the origin-of-movement host 9 and maintains the services. The virtual machine 21 stops until movement of the virtual machine 11 to the movement-destination host 10 is completed and starts the services as the virtual machine 21.

The virtual machine monitor 101 controls access of the virtual machine 21 to the computer hardware 102 and receives information on the virtual machine 11 when the virtual machine 11 moves from the origin-of-movement host 9 to the movement-destination host 10. This virtual machine monitor 101 is composed of a movement control unit 1011 which receives the information on the moving virtual machine 11 and a HW (Hardware) access control unit 224 which controls the access of the virtual machine 21 to the computer hardware 23. Operations of the movement control unit 1011 are described below.

FIG. 9 is a flowchart illustrating operations of the packet communication system related to the invention. Referring to FIG. 9, the operations of the movement control unit 911 in the origin-of-movement host 9 and the movement control unit 1011 in the movement-destination host 10 are described.

Initially, the movement control unit 911 receives a notice that the virtual machine 11 moves to the movement-destination host 10 (step c1). Next, the movement control unit 911 stops the virtual machine 11 at a constant period and transmits the dirty memory to the movement-destination host 10 (step c2). The movement control unit 911 repeats step c2 until the condition is met, in which an amount of data of the dirty memory transmitted during the constant period is smaller than an amount of data of memory which becomes dirty during the same period (step c3).

After the condition is met, the movement control unit 911 stops restart of the virtual machine 11 which stops at the constant period (step c4). Then, the movement control unit 911 instructs the dirty-memory detecting unit 121 to detect data (dirty memory) which the virtual machine 11 writes in the memory 132 between the previous stop time and the current stop time. Further, the movement control unit 911 instructs the dirty-memory detecting unit 121 to transmit the detected dirty memory to the transfer buffer 122. After that, the movement control unit 911 transmits the dirty memory of the virtual machine 11 stored in the transfer buffer 122 and the register information of the CPU 131 to the virtual machine monitor 101 in the movement-destination host 10 (step c5).

Next, the movement control unit 1011 receives information on the dirty memory of the virtual machine 11 which moves from the origin-of-movement host 9 with the constant period. The movement control unit 1011 reflects the received information to the memory 232 allocated for the virtual machine 21. The movement control unit 1011 receives the dirty memory at the time when the virtual machine 11 completely stop at the final stage of the movement in the origin-of-movement host 9, and the register information of the CPU 131. The movement control unit 1011 reflects the information of the dirty memory to the memory 232 and reflects the register information to the register information of the CPU 231, and starts the services by the virtual machine 21 (step c6).

After the virtual machine 21 is restarted, the movement control unit 1011 instructs the network switch A1 to restart packet transmission (step c7), and starts packet transmission and reception (step c8). The restart of the virtual machine 21 means the operation in which the services start in the same state as before the movement in the movement-destination host 10.

FIG. 10 is a flowchart illustrating detailed operations in step c2 of FIG. 9. Referring to FIG. 10, the operations in step c2 in the movement control unit 911 mentioned above (stopping the virtual machine 11 at the constant period and transmitting the dirty memory) is described in detail.

Initially, the movement control unit 911 stops the virtual machine 11 at the constant period (step c2-1). Next, the movement control unit 911 instructs the dirty-memory detecting unit 121 to detect data which the virtual machine 11 writes in the memory 132 between the previous stop time and the current stop time (step c2-2). After that, the movement control unit 911 instructs the dirty-memory detecting unit 121 to write the dirty memory detected at step c2-2 in the transfer buffer 122 (step c2-3). After that, the movement control unit 911 restarts the virtual machine 11 (step c2-4) and transmits the dirty memory of the virtual machine 11 written in the transfer buffer 122 to the movement-destination host 10 (step c2-5), and then the operations of step c2 in the flowchart of FIG. 9 are completed. The above operations are repeated until the condition of step c3 in FIG. 9 is met.

### SUMMARY

The exemplary object of the invention is to provide a technology to solve the issue that a packet which a virtual machine transmits and receives is lost when the virtual machine is moved.

A packet communication system of this application includes: a virtual machine unit; an origin-of-movement communication unit; a movement-destination communication unit; and a storage unit which stores a packet destined for the virtual machine unit while the virtual machine unit moves from the origin-of-movement communication unit to the movement-destination communication unit and transfers the stored packet to the movement-destination communication unit.

A switch of this application includes: a storage unit which stores a packet destined for a virtual machine unit while the virtual machine unit moves from an origin-of-movement communication unit including the virtual machine to movement-destination communication unit which is a movement destination of the virtual machine unit; and a transfer control unit which transfers the stored packet to the movement-destination communication unit.

A packet communication device of this application includes: a virtual machine unit; a storage unit which stores a packet destined for the virtual machine unit while the virtual machine unit moves from its own communication device to another communication device which is a movement destination of the virtual machine unit; and an origin-of-movement movement control unit which transfers the packet stored in the storage unit to the virtual machine unit.

A packet communication device of this application includes: a storage unit which stores a packet destined for a virtual machine unit while the virtual machine unit moves from other communication unit to its own communication device; and a movement-destination movement control unit which transfers the packet stored in the storage unit to the virtual machine unit.

A packet communication method of this application includes: storing a packet destined for virtual machine unit while the virtual machine unit moves from first communication unit to second communication unit; and transferring the stored packet to the second communication unit.

A computer-readable storage medium of this application includes a packet communication program recorded therein for causing a computer to execute a process of storing a packet destined for virtual machine in storage unit which stores a packet while the virtual machine unit moves from first communication unit to second communication unit and a process of transferring the stored packet to the second communication unit.

### BRIEF DESCRIPTION OF THE DRAWINGS

Exemplary features and advantages of the present invention will become apparent from the following detailed description when taken with the accompanying drawings in which:

FIG. 1 is a block diagram illustrating a structure of a packet communication system of a first exemplary embodiment of the invention;

FIG. 2 is a flowchart illustrating operations of a packet communication system of the first exemplary embodiment of the invention;

FIG. 3 is a block diagram illustrating a structure of a packet communication system of a second exemplary embodiment of the invention;

FIG. 4 is a flowchart illustrating operations of a packet communication system of the second exemplary embodiment of the invention;

FIG. 5 is a block diagram illustrating a structure of a packet communication system of a third exemplary embodiment of the invention;

FIG. 6 is a flowchart illustrating operations of a packet communication system of the third exemplary embodiment of the invention;

FIG. 7 is a block diagram illustrating a basic structure of a packet communication system of the invention;

FIG. 8 is a block diagram illustrating a structure of a packet communication system related to the invention;

FIG. 9 is a flowchart illustrating operations of a packet communication system related to the invention; and

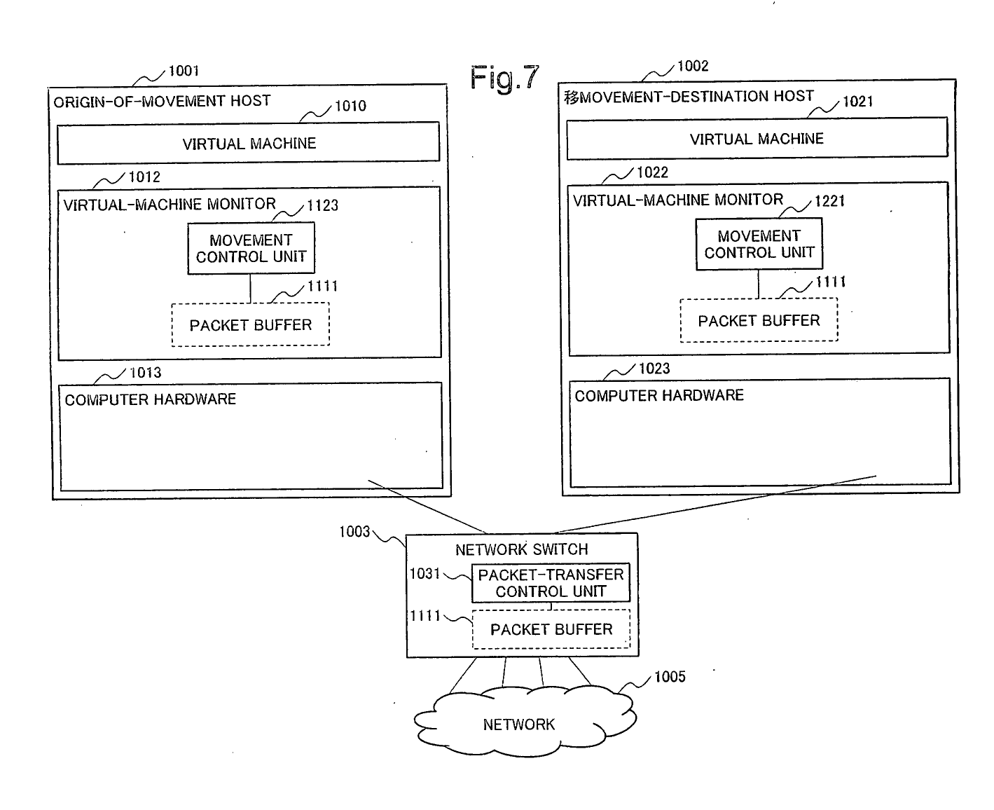

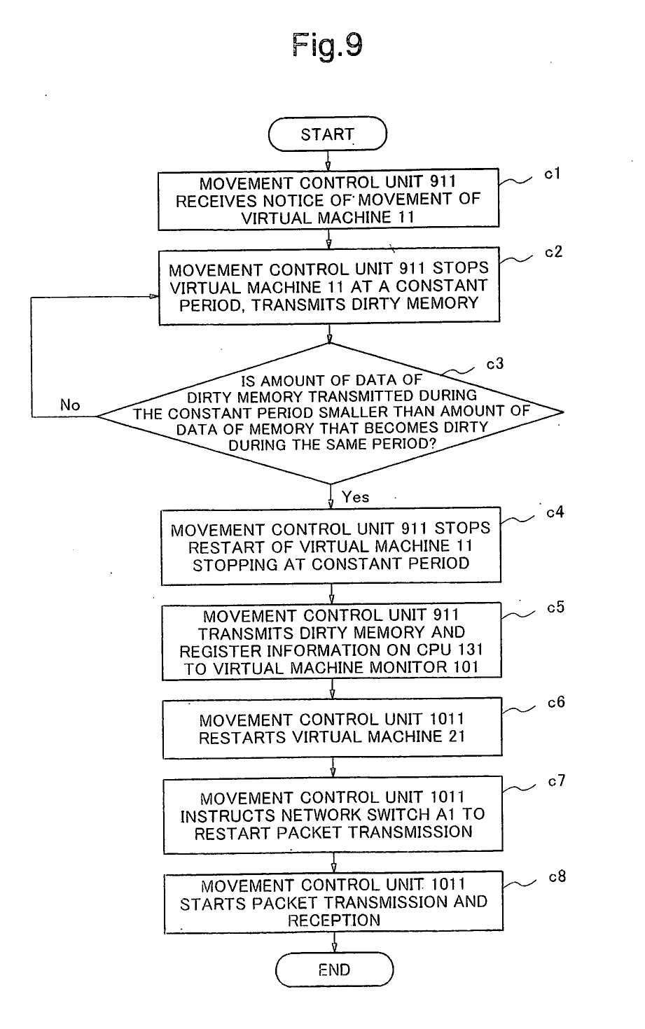

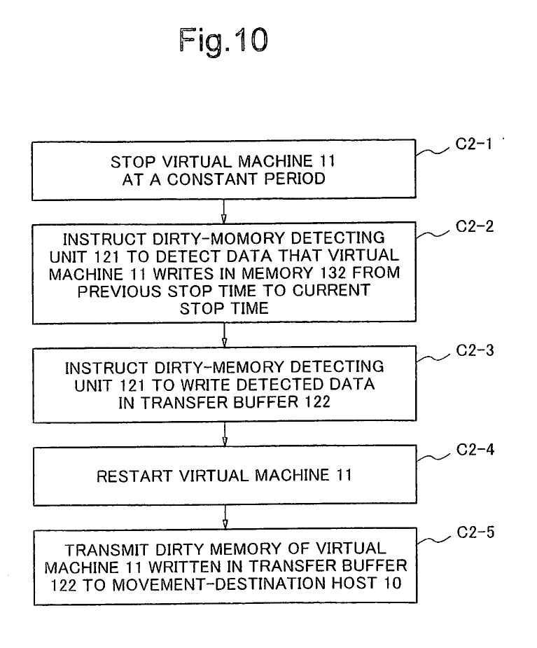

FIG. 7 is a flowchart illustrating detailed operations of step c2 in FIG. 9.

### EXEMPLARY EMBODIMENT

Next, referring to drawings, exemplary embodiments in which the invention is carried out are described in detail.

### [Basic Structure]

FIG. 7 is a block diagram illustrating a basic configuration of a packet communication system of the invention.

The packet communication system shown in FIG. 7 includes an origin-of-movement host 1001 (origin-of-movement communication device), a movement-destination host 1002 (movement-destination communication device), a network switch 1003, and a network 1005.

The origin-of-movement host 1001 includes a virtual machine 1010, a virtual machine monitor 1012, computer hardware 1013. The origin-of-movement host 1001 provides services before movement of the services accompanied with movement of the virtual machine 1010.

The virtual machine 1010 includes an operating system and application software, and provides services. The virtual machine monitor 1012 controls access to the computer hardware 1013 of the virtual machine 1010. The virtual machine monitor 1012 includes a movement control unit 1123 which transmits information on the virtual machine 1010 when the virtual machine 1010 moves to the movement-destination host 1002.

The movement-destination host 1002 is a movement-destination which takes over the services after movement of the virtual machine 1010.

After the virtual machine 1010 in the origin-of-movement host 1001 moves to the movement-destination host 1002, a virtual machine 1021 takes over the services which the virtual machine 1010 has provided. The virtual machine 1021 stops until the movement of the virtual machine 1010 to the movement-destination host 1002 is completed and the services as the virtual machine 1021 start.

A virtual machine monitor 1022 includes a movement control unit 1221. The movement control unit 1221 receives information on the virtual machine 1010 when the virtual machine 1021 moves from the origin-of-movement host 1001 to the movement-destination host 1002. The movement control unit 1221 restarts the virtual machine 1021 after completion of the reception and controls the timing of packet transmission to the virtual machine 1021 of the network switch 1003.

The network switch 1003 connects the origin-of-movement host 1001 and the movement-destination host 1002 and transfers a packet. The network switch 1003 is connected to the network 1005.

Further, a packet buffer 1111 (storage unit) exists, which temporarily stores a packet destined for the virtual machine 1010 and the virtual machine 1021 which is received from the network 1005.

The packet buffer 1111 is allowed to be located in any place. The packet buffer 1111 may be arranged within at least one of the origin-of-movement host 1001, the movement-destination host 1002, and the network switch 1003. FIG. 7 illustrates the packet buffers 1111 which are located within the virtual machine monitor 1012 of the origin-of-movement host 1001, the virtual machine monitor 1022 of the movement-destination host 1002, and the network switch 1003.

In a first exemplary embodiment, a configuration in which the packet buffer is placed within the network switch and operations thereof are described in detail. In a second exemplary embodiment, a configuration in which the packet buffer is placed within the origin-of-movement host and operations thereof are described in detail. In a third exemplary embodiment, a configuration in which the packet buffer is placed within the movement-destination host and operations thereof are described in detail.

### First Exemplary Embodiment

[Structure]

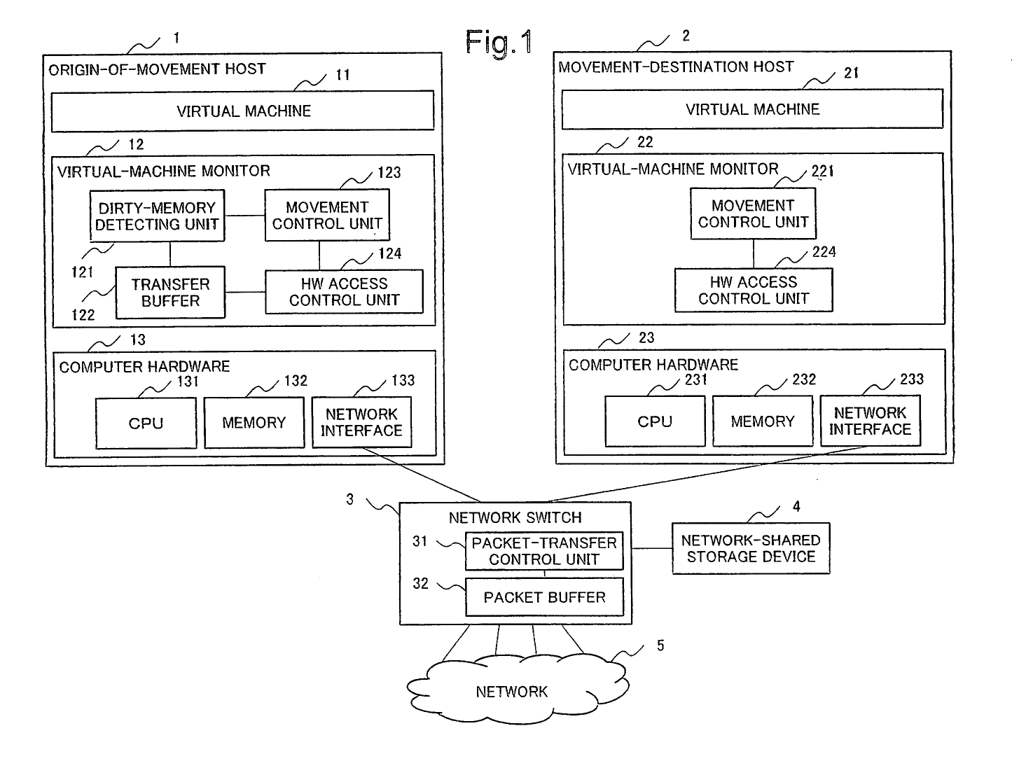

FIG. 1 is a block diagram illustrating a structure of a packet communication system of the first exemplary embodiment in the invention.

Referring to FIG. 1, the packet communication system of the first exemplary embodiment of the invention includes an origin-of-movement host 1, a movement-destination host 2, a network switch 3, a network-shared storage device 4, and a network 5.

The origin-of-movement host 1 provides services until the services moves with movement of a virtual machine. The movement-destination host 2 is a destination which takes over the services with movement of the virtual machine. The network switch 3 connects the origin-of-movement host 1, the movement-destination host 2 and the network-shared storage device 4, and performs packet transfer. The network switch 3 is connected to the network 5. The network-shared storage device 4 is a shared storage device for the origin-of-movement host 1 and the movement-destination host 2.

The origin-of-movement host 1 includes a virtual machine 11, a virtual machine monitor 12 and computer hardware 13.

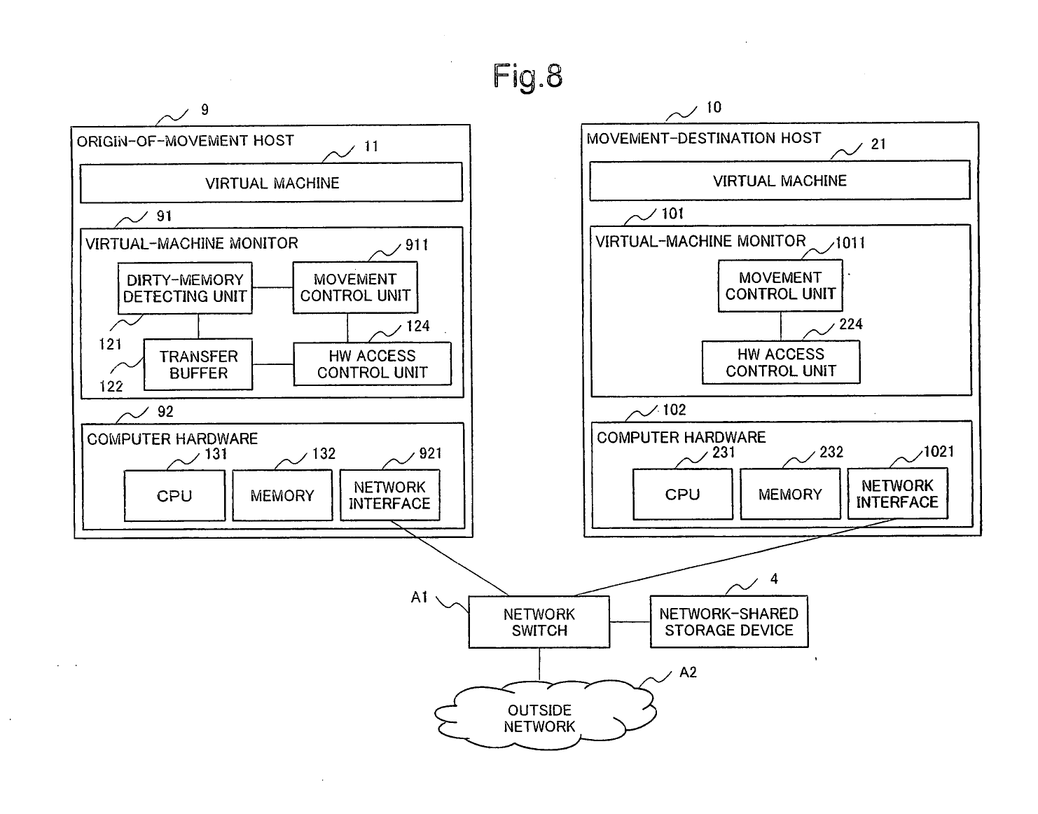

The computer hardware 13 includes a CPU 131 for computing, a memory 132, a network interface 133 for connecting the origin-of-movement host 1 and the network switch 3, and the like. The CPU 131 and the memory 132 are similar to the CPU 131 and the memory 132 in FIG. 8, respectively.

The virtual machine 11 includes an operating system and application software, and provides services.

The virtual machine monitor 12 controls access of the virtual machine 11 to the computer hardware 13. The virtual machine monitor 12 transmits information on the virtual machine 11 to the movement-destination host 2 when the virtual machine 11 moves to the movement-destination host 2, and controls timing of switching a packet which the network switch 3 transmits to the virtual machine 11. This virtual machine monitor 12 includes a movement control unit 123, a transfer buffer 122 and a dirty-memory detecting unit 121.

The transfer buffer 122 is arranged in the memory 132, and stores information on dirty memory to be transmitted to the movement-destination host 10. The dirty-memory detecting unit 121 detects data which the virtual machine 11 writes in the memory 132, and writes the detected data in the transfer buffer 122. The movement control unit 123 receives a notice that the virtual machine 11 moves to the movement-destination host 2, and transmits the dirty memory of the virtual machine 11 to the movement-destination host 2. Detailed operations of the movement control unit 123 are described below.

The network switch 3 includes a packet-transfer control unit 31 and a packet buffer 32, and provides a function of packet transfer to the network 5.

The packet buffer 32 temporarily stores a packet. The start time of storing the packet is the time when the packet-transfer control unit 31 receives a packet transmission stopping instruction destined for the virtual machine 11 from the movement control unit 123 in the origin-of-movement host 1. The end time of the packet storing is the time when a virtual machine 21 restarts operation in response to an operation state of the virtual machine 11 which is moved in the movement-destination host 2 and the packet-transfer control unit 31 receives a packet transmission restarting instruction destined for the virtual machine 21. Detailed operations of the packet-transfer control unit 31 are described below.

The movement-destination host 2 includes the virtual machine 21, computer hardware 23 and a virtual machine monitor 22.

The structure of the computer hardware 23 is similar to the structure of the computer hardware 13 included in the origin-of-movement host 1, and includes a CPU 231, a memory 232, a network interface 233, and the like.

When services in the virtual machine 11 are taken over by the virtual machine 21, in other words, when the virtual machine 11 in the origin-of-movement host 1 completes movement into the movement-destination host 2, the virtual machine 21 starts the services.

The virtual machine monitor 22 includes a movement control unit 221. The movement control unit 221 receives information on the virtual machine 11 when the virtual machine 23 moves from the origin-of-movement host 1 to the movement-destination host 2. The movement control unit 221 restarts the virtual machine 23 after completion of receiving the information on the virtual machine 11, and controls timing of transmitting a packet to the virtual machine 21 of the network switch 3. Operations of the movement control unit 211 are described below.

[Operations]

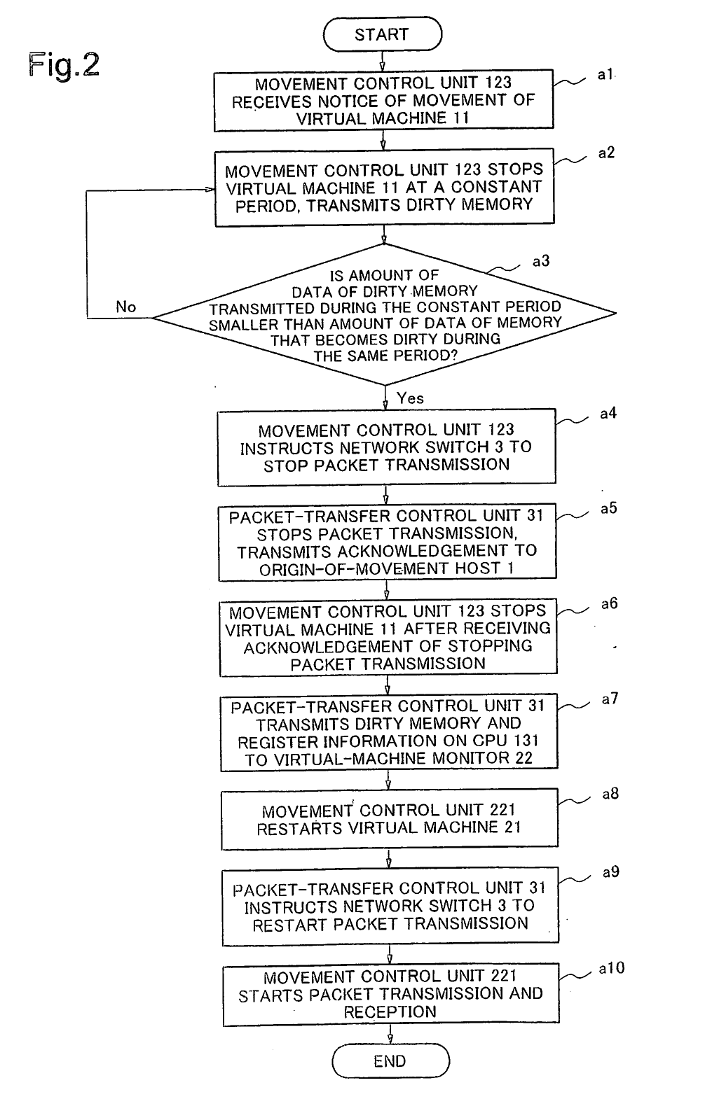

Next, referring to the flowchart shown in FIG. 2, operations of the first exemplary embodiment for performing the invention are described. As described below, each operation of the movement control unit 123 in the origin-of-movement host 1, the movement control unit 221 in the movement-destination host 2, and the packet-transfer control unit 31 in the network switch 3 is mainly described in detail.

Initially, the movement control unit 123 in the origin-of-movement host 1 receives a notice that the virtual machine 11 moves to the movement-destination host 2 (step a1).

Subsequently, the movement control unit 123 stops the virtual machine 11 at a constant period and transmits the dirty memory to the movement-destination host 2 (step a2). Being similar to the operation in step c2 in the flowchart in FIG. 10 which is already described, an operation in step a2 is described here with reference to the flowchart in FIG. 10.

Initially, the movement control unit 123 stops the virtual machine 11 at a constant period (step c2-1). Next, the movement control unit 123 instructs the dirty-memory detecting unit 121 to detect data which the virtual machine 11 writes in the memory 132 between the previous stop time and the current stop time (step c2-2). After that, the movement control unit 123 instructs the dirty-memory detecting unit 121 to write data detected at step c2-2 in the transfer buffer 122 (step c2-3). After that, the movement control unit 123 restarts the virtual machine 11 (step c2-4) and transmits the dirty memory of the virtual machine 11 written in the transfer buffer 122 to the movement-destination host 2 (step c2-5), and then the operation of step c2 is completed. The above operations are repeated until the condition of step a3 in the flowchart of FIG. 2 is met.

The movement control unit 123 repeats step a2 until the condition is met, in which an amount of data of the dirty memory transmitted during a constant period is smaller than an amount of data of the memory which becomes dirty during the same period (step a3). The above operations are similar to those of steps c1 to c3 in FIG. 9.

After the condition of step a3 is met, the movement control unit 123 instructs the network switch 3 to stop transmission of a packet destined for the virtual machine 11 (step a4). The packet-transfer control unit 31 in the network switch 3 receives the instruction to stop transmission of the packet destined for the virtual machine 11, stops packet transmission, and transmits acknowledgement to the origin-of-movement host 1 (step a5). The packet buffer 32 starts to store the packet destined for the virtual machine 11 received from the network 5, from the time when the packet-transfer control unit 31 receives the instruction to stop transmission of the packet destined for the virtual machine 11. The movement control unit 123 receives the acknowledgement on stopping packet transmission destined for the virtual machine 11, waits for completion of transmitting a network packet received from the network switch 3 to the virtual machine 11 before reception of the acknowledgement, and stops operations of the virtual machine 11 after completion of the packet transmission (step a6). Following that, the packet-transfer control unit 31 transmits memory information which becomes dirty between the previous stop time of the virtual machine 11 and the stage of finally stopping the virtual machine 11 and register information on CPU 131, to the movement-destination host 2 (Step a7).

After that, the origin-of-movement host 1 stops performance of the virtual machine 11, the movement control unit 221 in the movement-destination host 2 receives dirty memory of the virtual memory 11 and the register information of CPU 131 from the origin-of-movement host 1. After these are completed, the movement control unit 221 restarts operation of the virtual machine 21 so that the virtual machine 21 takes over the operation state of the virtual machine 11 operating in the origin-of-movement host 1 (step a8). Subsequently, the movement control unit 221 instructs the network switch 3 to restart transmission of the packet destined for the virtual machine 21 (step a9). The packet-transfer control unit 31 receives the instruction to restart transmission of the packet destined for the virtual machine 21, and transmits the packet stored in the packet buffer 32 to the virtual machine 21 in order of storing. The packet-transfer control unit 31 starts transmission of a packet which is newly received from the network 5 and destined for the virtual machine 21 (step a10). The packet buffer 32 stores the packet destined for the virtual machine 21 received from the network 5 until the packet-transfer control unit 31 receives the transmission restarting instruction of the packet destined for the virtual machine 21. That is a series of operations at the time when the virtual machine moves from the origin-of-movement host 1 to the movement-destination host 2, in the embodiment.

The exemplary embodiment makes it a condition that an amount of data of the dirty memory transmitted in a constant period is smaller than an amount of data of memory which becomes dirty in the constant period above described (step a3), in transition from the step in which the virtual machine 11 is stopped at the constant period and the dirty memory is transmitted to the movement-destination host 2 (step a2) to the step in which the virtual machine 11 is completely stopped and the dirty memory and the register information of CPU 131 are transmitted to the movement-destination host 2 (from step a4)

However, the condition of the transition between the two stages is not limited to this. For example, timeout of a timer, the number of transmission of the dirty memory repeated at a constant period, and the like may be set as the condition.

In the present exemplary embodiment, step a2 and step a3 are repeated until the above condition is met, in the transition from step a2 to step a4. However, it is not necessarily to repeat these steps. Although, these are usually repeated in fact, a configuration in which each of step a2 and step a3 is performed once is possible.

[Effect]

Next, effects of the first exemplary embodiment are described.

In the first exemplary embodiment, packet transmission destined for the virtual machine is stopped before stop of the virtual machine and movement thereof. The packet buffer in the network switch temporarily stores the packet destined for the virtual machine received from the network until the packet-transfer control unit receives the packet transmission restarting instruction destined for the moved virtual machine, after the packet-transfer control unit receives the packet transmission stopping instruction.

As described above, in the first exemplary embodiment, the network switch temporarily stores the packet destined for the virtual machine received during movement of the virtual machine, in the packet buffer. The network switch restarts transmission of the stored packet after movement of the virtual machine. Thereby, in the first embodiment, loss of the packet destined for the virtual machine during movement of the virtual machine is prevented.

Therefore, the first exemplary embodiment provides a first effect in which it is possible to move the virtual machine without losing the packet which the virtual machine transmits and receives while the virtual machine moves from the origin-of-movement host to the movement-destination host.

The second effect of the first exemplary embodiment is that it is possible to achieve a function for packet loss prevention without changing existing programs which are executed in the virtual machine.

The reason is that packet transmission and reception through the network switch is controlled in the layer of the virtual machine monitor in the first exemplary embodiment. That is, the function for packet loss prevention is achieved without dependence on the programs of the virtual machine.

Additionally, the communication system with the minimum configuration including only the virtual machine 11, the origin-of-movement host 1, the movement-destination host 2 and the packet buffer 32, provides the effect of the first exemplary embodiment. That is, in the communication system with the minimum configuration, the packet buffer 32 stores the packet destined for the virtual machine 11 while the virtual machine 11 moves from the origin-of-movement host 1 to the movement-destination host 2. When the virtual machine 11 moves to the movement-destination host 2, the packet buffer 32 transfers the stored packet to the movement-destination host 2.

As a result, even in the communication system with the minimum configuration, the effect, similar to the first effect of the first exemplary embodiment in which it is possible to move the virtual machine without losing the packet which the virtual machine transmits and receives during movement of the virtual machine, is provided.

The communication system with the minimum configuration described above controls packet transmission and reception in the layer of the virtual machine monitor. Accordingly, the communication system with the minimum configuration provides the effect similar to the second effect of the above first embodiment in which the function for packet loss prevention without changing existing programs which are executed in the virtual machine is achieved.

The switch described in the first exemplary embodiment further includes the packet buffer 32 storing the packet destined for the virtual machine while the virtual machine moves from the origin-of-movement host to the movement-destination host, and the packet-transfer control unit 31 transferring the stored packet to the movement-destination communication device.

The switch having such structure described in the first exemplary embodiment stores the packet destined for the virtual machine 11 while the virtual machine 11 moves from the origin-of-movement host 1 to the movement-destination host 2. When the virtual machine 11 moves to the movement-destination host 2, the packet buffer 32 transfers the stored packet to the movement-destination host 2.

As a result, the switch described in the first exemplary embodiment provides the effect, similar to the first effect of the first exemplary embodiment in which it is possible to move the virtual machine without losing the packet which the virtual machine transmits and receives during movement of the virtual machine.

Further, the switch described in the first exemplary embodiment controls packet transmission and reception without dependence on the existing programs which operate in the virtual machine. Accordingly, the communication system with the minimum configuration provides the effect similar to the second effect of the above first exemplary embodiment in which the function for packet loss prevention without changing the existing programs which operate in the virtual machine is achieved.

### Second Exemplary Embodiment

Next, a second exemplary embodiment for executing the invention is described in detail with reference to drawings.

[Structure]

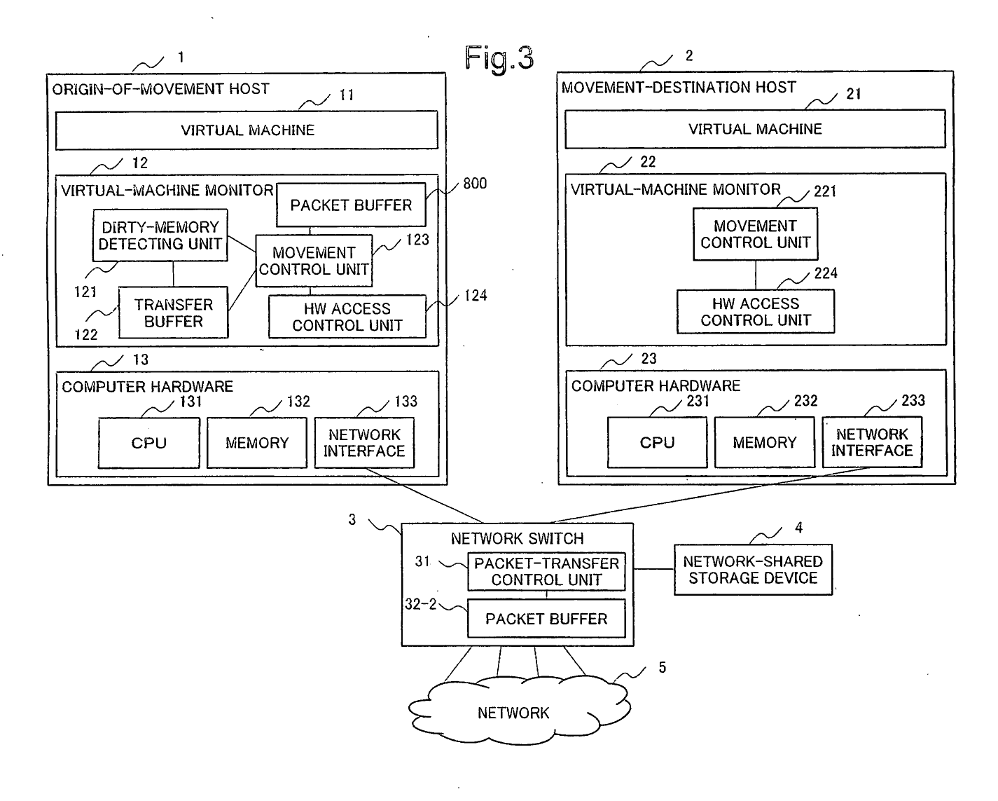

FIG. 3 is a block diagram illustrating the structure of a packet communication system of the second exemplary embodiment of the invention. The structure of the packet communication system shown in FIG. 3 differs only in a position of the packet buffer compared with the first exemplary embodiment. In the first exemplary embodiment, the packet buffer 32 is placed in the network switch 3 (FIG. 1). With reference to FIG. 3, the second exemplary embodiment has a structure in which the origin-of-movement host 1 includes a packet buffer 800 in addition to a packet buffer 32-2 in the network switch 3.

The packet buffer 800 placed in the origin-of-movement host 1 stores a packet destined for the virtual machine 11 received from the network 5 until the virtual machine restarts as the virtual machine 21 after movement thereof, after the virtual machine stops.

The packet buffer 32-2 in the network switch 3 stores the packet destined for the virtual machine 11 received from the network 5 until the virtual machine 21 restarts packet transmission and reception after the virtual machine 11 restarts as the virtual machine 21 after movement.

Since the other structure is the same as that of the first exemplary embodiment, detailed descriptions are omitted.

The structure in which the packet buffer 32-2 is placed in the network switch 3 is described here. However, a structure in which the packet buffer 32-2 is placed in the movement-destination host 2 is possible.

[Operations]

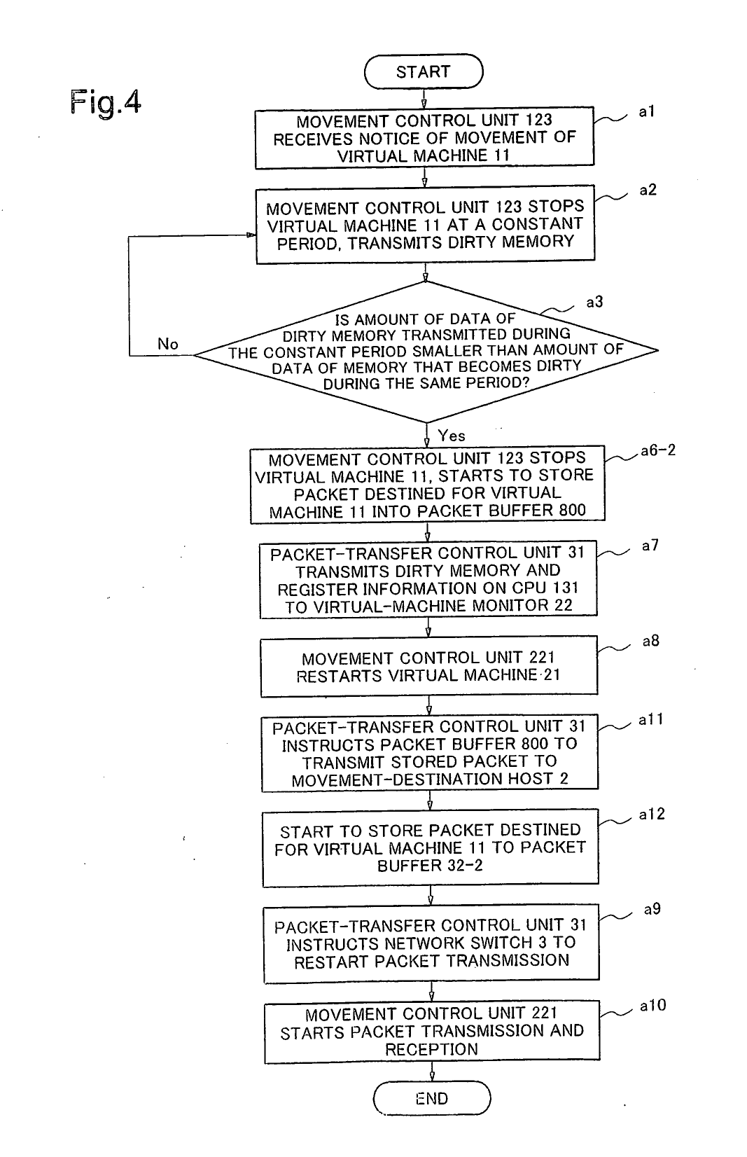

Next, referring to FIG. 4, the second exemplary embodiment is described. With reference to FIG. 4, operations in the second exemplary embodiment differ in lack of step a4 and step a5, a different operation of step a6 (illustrated as step a6-2 in FIG. 4) and newly added step a 11 and step a12, compared with the operations of the first exemplary embodiment (FIG. 2). Differences from the operations of the first exemplary embodiment are mainly described here.

In the first exemplary embodiment, the packet-transfer control unit 31 placed in the network switch 3 stores the packet destined for the virtual machine 11 received from the network 5 after step a5 of FIG. 2 in the packet buffer 32 in the network switch 3.

In the second exemplary embodiment, since the packet buffer 800 is arranged in the origin-of-movement host 1, step a4 and step a5 are unnecessary and, step a11 and step a12 are newly added.

In step a4 and step a5, the movement control unit 221 in the origin-of-movement host 2 instructs the network switch 3 to stop packet transmission (step a4), and the packet-transfer control unit 31 stops packet transmission and transmits the acknowledgement to the origin-of-movement host 1 (step a5). In the second exemplary embodiment, since the packet buffer 800 is arranged in the origin-of-movement host 1, communication between the origin-of-movement host 1 and the network switch 3 in step a4 and step a5 is unnecessary. In the second exemplary embodiment, therefore, step a4 and step a5 are deleted.

In the second exemplary embodiment, step a6 is changed into step a6-2, compared with the first exemplary embodiment. Step a6 of the first exemplary embodiment is only the operation that the movement control unit 123 stops the virtual machine 11. In step a6-2, the movement control unit 123 stops the virtual machine 11, and at the same time, the packet buffer 800 starts to store the packet destined for the virtual machine 11 received from the network 5.

Following that, operations in step a11 and step a12 are described. Step a11 and step 12 are executed after step a8 in which the movement control unit 221 restarts the virtual machine 21. After the movement control unit 221 restarts the virtual machine 21 in step a8, the movement control unit 221 instructs the origin-of-movement host 1 via the network switch 5 to transmit the packet stored in the packet buffer 800 in the origin-of-movement host 1 to the virtual machine 11 in the movement-destination host 2 (step a11). At the time, storing the packet destined for the virtual machine 11 into the packet buffer 800 is completed.

Following step a11, the network switch 3 starts to store the packet destined for the virtual machine 21 received from the network 5 into the packet buffer 32-2 in the network switch 3 (step a12). In addition, storing the packet destined for the virtual machine 21 into the packet buffer 32-2 is conducted before the movement control unit 221 restarts packet transmission and reception at step a 10.

Since operations other than the above descriptions are similar to those of the first exemplary embodiment, detailed descriptions thereof are omitted.

In the above descriptions on the structure, though the configuration is described, in which the packet buffer 32-2 does not need to be located in the network switch 3 and may be placed in the movement-destination host 2, even in such configuration, only one change of operation is performed. In step a9, the packet-transfer control unit 31 instructs the network switch 3 to restart packet transmission. However, in a configuration in which the packet buffer 32-2 is located in the movement-destination host 2, the packet-transfer control unit 31 instructs the movement control unit 221 in the movement-destination host 2, not the network switch 3, to restart packet transmission. The other operations may be executed without change.

[Effect]

Next, effects of the second exemplary embodiment are described.

In the second exemplary embodiment, the packet buffer is located in each of the origin-of-movement host and the network switch. The packet destined for the virtual machine received from the network is stored in the packet buffer located in the origin-of-movement host, until the virtual machine moves and restarts after the virtual machine stops. The packet destined for the virtual machine received from the network is stored in the packet buffer in the network switch until the virtual machine restarts packet transmission and reception after the virtual machine moves and restarts.

As described above, when the packet destined for the virtual machine received during movement of the virtual machine is temporarily stored in the packet buffer, and when transmission of the stored packet destined for the virtual machine restarts after movement of the virtual machine, loss of the packet destined for the virtual machine during movement of the virtual machine is prevented.

In the second exemplary embodiment, therefore, it is possible to move the virtual machine without losing packet which the virtual machine transmits and receives, while the virtual machine moves from the origin-of-movement host to the movement-destination host.

Another effect of the second exemplary embodiment is to achieve the function of packet loss prevention without changing the existing programs executed in the virtual machine, like the first embodiment.

The reason is that packet transmission and reception through the network switch is controlled in the layer of the virtual machine monitor in the second embodiment. The function of packet loss prevention is achieved without depending on the programs of the virtual machine.

### Third Exemplary Embodiment

Referring drawings, a third exemplary embodiment for executing the invention is described in detail.

[Structure]

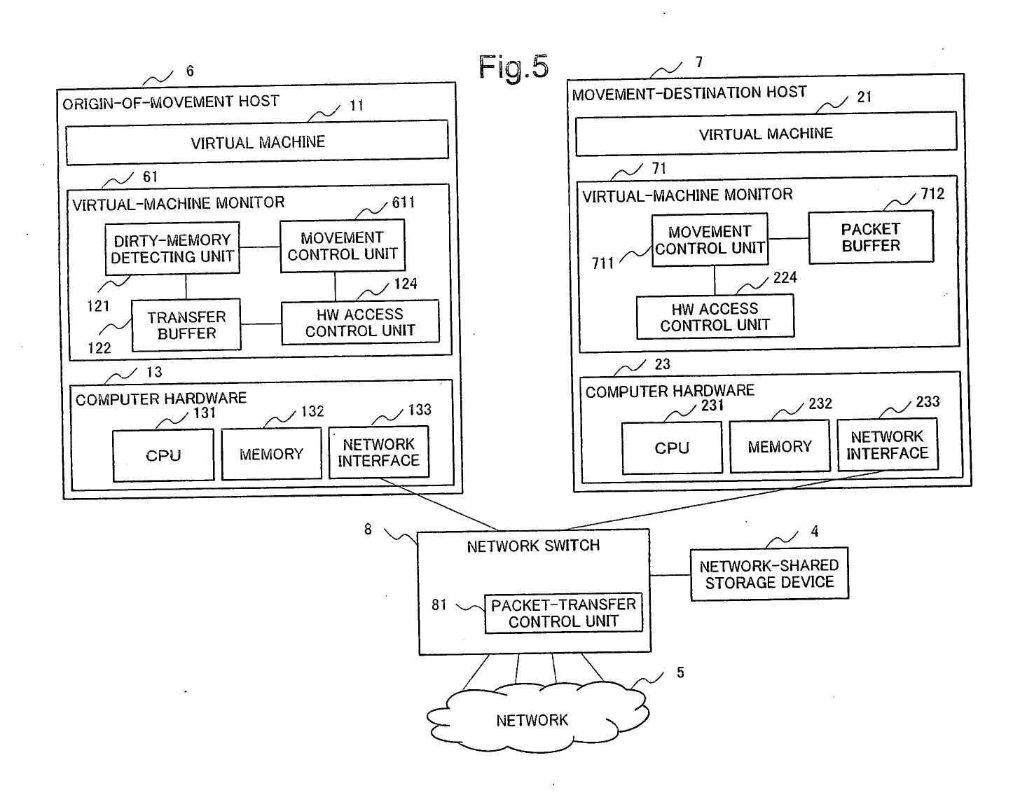

FIG. 5 is a block diagram illustrating a configuration of a packet communication system of the third exemplary embodiment of the invention.

With reference to FIG. 5, compared with the configuration of the packet communication system shown in FIG. 1, the configuration of the packet communication system of the third exemplary embodiment differs in including a virtual machine monitor 61 in place of the virtual machine monitor 12 in the origin-of-movement host 6, a virtual machine monitor 71 in place of the virtual machine monitor 22 in an movement-destination host 7, and packet-transfer control unit 81 in place of the packet-transfer control unit 31 in a network switch 8. Regarding a movement control unit 611 in the virtual machine monitor 61 and a movement control unit 711 in the virtual machine monitor 71, operations thereof are different compared with the first exemplary embodiment.

The structure of the third exemplary embodiment (FIG. 5) differs in lacking the packet buffer 32 placed in the network switch 3 and arranging a packet buffer 712 in the movement-destination host 7, compared with the structure of the first exemplary embodiment.

The packet buffer 712 placed in the movement-destination host 7 starts to store the packet destined for the virtual machine 11 received from the network 5 after the virtual machine 11 completely stops. The packet buffer 712 stores the packet destined for the virtual machine 11 received from the network 5 until the virtual machine 11 restarts packet transmission and reception as the virtual machine 21 in the movement-destination host 7. After the virtual machine 11 restarts as the virtual machine 21 in the movement-destination host 7 and an address of a packet destined for the virtual machine 11 received from the network 5 changes from the virtual machine 11 to the virtual machine 21, the packet buffer 712 completes storing the packet destined for the virtual machine 11. After that, packet transmission to the virtual machine restarts with a packet transferred from the origin-of-movement host 6 in order.

Since the other structure is similar to that of the first exemplary embodiment, detailed description is omitted.

[Operations]

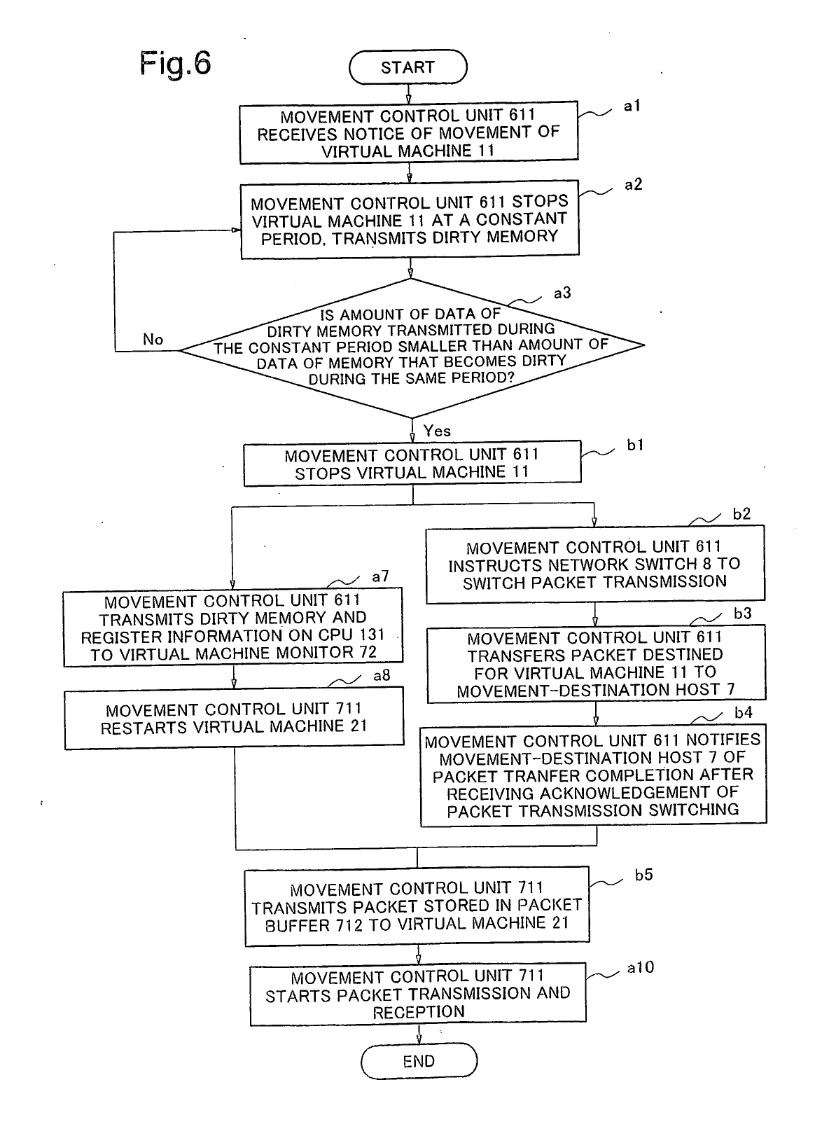

Next, referring to a flowchart shown in FIG. 6, operations of the packet communication system of the third exemplary embodiment for executing the invention are described. In particular, operations of the movement control unit 123 in the origin-of-movement host 6, the movement control unit 711 in the movement-destination host 7, and the packet-transfer control unit 81 in the network switch 8 are mainly described below in detail.

Referring to the flowchart of FIG. 6, the packet communication system of the third exemplary embodiment for executing the invention differs in including steps b1 to b5 from the first exemplary embodiment (FIG. 2).

Initially, the movement control unit 611 of the origin-of-movement host 6 receives a notice that the virtual machine 11 moves to the movement-destination host 7 (step a1). Next, the movement control unit 611 stops the virtual machine 11 at a constant period, and transmits information on dirty memory to the movement-destination host 7 (step a2). And since the operation of step a2 is similar to the operation of step c2 described above (FIG. 9, FIG. 10) like the first exemplary embodiment, detailed descriptions are omitted. After step a2, the movement control unit 611 repeats step a2 until the condition is met, in which an amount of data of dirty memory transmitted during a constant period is smaller than an amount of data of memory which becomes dirty during the same period (step a3). These operations are similar to steps c1 to c3 in FIG. 9, and steps a1 to a3 in FIG. 2 (first embodiment).

Next, the movement control unit 611 stops the virtual machine 11 (step b1). After the virtual machine 11 stops, the packet buffer 712 in the movement-destination host 7 starts to store the packet destined for the virtual machine 11 received from the network 5.

In the third embodiment, (1) steps a7 to a8 and (2) steps b2 to b4 are executed in parallel, after step b1. The processes (1) and (2), however, do not necessarily have to be parallel processes. As long as migration to step b5 is performed after processes of step a8 and step b4 are completed, one of them may be executed first and the other may be executed after that.

The movement control unit 611 instructs the dirty-memory detecting unit 121 to detect data (dirty memory) which the virtual machine 11 writes in the memory 132 between the previous stop time and the current stop time. Then the movement control unit 611 instructs the dirty-memory detecting unit 121 to transmit the detected dirty memory to the transfer buffer 122. After that, the movement control unit 611 transmits the dirty memory stored in the transfer buffer 122 and register information of the CPU 131 to the movement-destination host 7 (step a7). Subsequently, the movement control unit 711 in the movement-destination host 7 restarts the virtual machine which is the virtual machine 11 before movement as the virtual machine 21, after the origin-of-movement host 6 stops execution of the virtual machine 11 and reception of the dirty memory of the virtual machine 11 and the register information of the CPU 131 from the origin-of-movement host 6 are completed (step a8).

Steps b2 to b4 described below are executed in parallel to steps a7 to a8. After stop of the virtual machine 11 (step b1), the movement control unit 611 instructs the network switch 8 to switch transmission of the packet destined for the virtual machine 11 into the movement-destination host 7 (step b2). After step b2, the packet destined for the virtual machine transmitted to the movement-destination host 7 is stored in the packet buffer 712 in the virtual machine monitor 71 by the movement control unit 711 until the virtual machine 11 moves to the movement-destination host 7 and starts execution as the virtual machine 21. After stopping the virtual machine 11, the movement control unit 611 transfers the packet destined for the virtual machine 11 received from the network switch 8 to the movement-destination host 7 (step b3). Following that, the movement control unit 611 receives an acknowledgement that packet transmission destined for the virtual machine 11 is switched to the movement-destination host 7, from the network switch 8. The movement control unit 611 notifies the movement-destination host 7 of completion of transferring the packet destined for the virtual machine 11 (step b4).

After parallel processes of steps a7 to a8 and steps b2 to b4 mentioned above are completed, the packet buffer 712 completes storage of the packet destined for the virtual machine 11 received from the network 5. Receiving the notice that transfer of the packet destined for the virtual machine 11 is completed from the origin-of-movement host 6 (step b4), the movement control unit 711 transfers the packet stored in the packet buffer 712 of the virtual machine monitor 71 to the virtual machine 21 which starts execution (step a8). Initially, the packet transferred from the origin-of-movement host 6 is transferred to the virtual machine 21, and next, the packet received from the network switch 8 is transferred to the virtual machine 21 (step b5). After that, the movement control unit 711 starts packet transmission and reception between the network switch 8 and the virtual machine 21 (step a10). The above are a series of operations at the time when the virtual machine 11 moves from the origin-of-movement host 6 to the movement-destination host 7, in the exemplary embodiment.

In the exemplary embodiment, with respect to the transition from the stage where the virtual machine 11 is stopped at a constant period and the dirty memory is transmitted to the movement-destination host 7 to the stage where the virtual machine is completely stopped and the dirty memory and the register information of CPU 131 are transmitted to the movement-destination host 7, the condition thereof is that the amount of data of the dirty memory transmitted during the constant period is smaller than the amount of data of memory which becomes dirty during the same period (step a3). However, the condition of the transition between both of the stages is not limited to that, like the configuration of the first exemplary embodiment, and may be set to timeout of a timer or the number of transmission of the dirty memory repeated at a constant period.

[Effect]

Next, effects of the third exemplary embodiment are described.

In the third exemplary embodiment, the packet buffer placed in the movement-destination host starts to store the packet destined for the virtual machine received from the network after the virtual machine completely stops. The packet buffer stores the packet destined for the virtual machine received from the network until the virtual machine restarts packet transmission and reception in the movement-destination host. After the virtual machine restarts as the virtual machine in the movement-destination host and the address of the packet destined for the virtual machine received from the network is switched, the packet buffer completes storage of the packet destined for the virtual machine. After that, packet transmission to the virtual machine restarts with a packet transferred from the origin-of-movement host in order.

When the packet destined for the virtual machine received during movement of the virtual machine is temporarily stored in the packet buffer and transmission of the stored packet is restarted after movement of the virtual machine, loss of the packet destined for the virtual machine during movement of the virtual machine is prevented.

According to the third exemplary embodiment, even when the network switch does not have the packet buffer corresponding to virtual machine movement and switching a destination of packet transmission is only performed, the virtual machine can be moved without loss of the packet which the virtual machine transmits and receives while the virtual machine moves from the origin-of-movement host to the movement-destination host.

Another effect of the third exemplary embodiment is that it is possible to achieve the function of packet loss prevention without changing the existing programs executed in the virtual machine, like the first and second embodiments.

The reason is that packet transmission and reception through the network switch is controlled in the layer of the virtual machine monitor, in the third exemplary embodiment. That is, the packet loss prevention function is achieved without dependence on the programs of the virtual machine.

In the first and second exemplary embodiment described above, it is described that the packet destined for the virtual machine received from the network is stored in the packet buffer arranged in the network switch only for a predetermined period. However, the configuration of the invention is not limited to the above configuration. A configuration is possible, in which transfer is certainly carried out through the packet buffer in the network switch when the network switch receives the packet destined for the virtual machine.

As described above, the packet communication system of the first to third exemplary embodiments includes the virtual machine, the origin-of-movement host, the movement-destination host, and the packet buffer. The packet buffer stores the packet destined for the virtual machine while the virtual machine moves from the origin-of-movement host to the movement-destination host, and transfers the stored packet to the movement-destination host. Due to such configuration, the packet communication system of the invention includes the effects that the packet which the virtual machine transmits and receives is not lost while the virtual machine moves from the origin-of-movement host to the movement-destination host.

The origin-of-movement host, the movement-destination host, and the network switch which are the first, second, and third exemplary embodiments described above may be achieved by hardware, soft ware, or a combination thereof.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A packet communication system, comprising:
a virtual machine unit;
an origin-of-movement communication unit;
a movement-destination communication unit; and
a storage unit which stores a packet destined for said virtual machine unit while said virtual machine unit moves from said origin-of-movement communication unit to said movement-destination communication unit and transfers said stored packet to said movement-destination communication unit.

2. The packet communication system of claim 1, further comprising:
a switch unit which connects said origin-of-movement communication unit and said movement-destination communication unit through a network, wherein said switch unit comprises said storage unit.

3. The packet communication system of claim 2, wherein
said origin-of-movement communication unit comprises an origin-of-movement movement control unit which transmits a packet transmission stopping instruction destined for said virtual machine unit to said switch unit, receives an acknowledgement of stopping packet transmission from said switch unit, stops said virtual machine unit after completion of transmission of said packet destined for said virtual machine unit which is received from said switch unit before reception of said acknowledgement of stopping packet transmission, and moves said virtual machine unit to said movement-destination communication unit, and
said movement-destination communication unit comprises a movement-destination movement control unit which restarts said moved virtual machine unit and transmits a packet transmission restarting instruction destined for said stopped virtual machine unit to said switch unit.

4. The packet communication system of claim 1, wherein said origin-of-movement communication unit comprises said storage unit.

5. The packet communication system of claim 4, further comprising:
a switch unit which connects said origin-of-movement communication unit and said movement-destination communication unit through a network, wherein said switch unit comprises an in-switch storage unit which stores a packet destined for said virtual machine unit received from said network until said virtual machine unit restarts packet transmission and reception after said virtual machine unit restarts after movement.

6. The packet communication system of claim 5, wherein said switch unit comprises transfer control unit which instructs to transmit said packet stored in said storage unit to said movement-destination communication unit and starts to store said packet destined for said virtual machine in said in-switch storage unit after said virtual machine unit restarts after movement, completes storing said packet destined for said virtual machine unit in said in-switch storage unit and transfers said packet destined for said virtual machine unit stored in said in-switch storage unit to said virtual machine unit after transmission of said packet stored in said storage unit to said movement-destination communication unit.

7. The packet communication system of claim 1, wherein said movement-destination communication unit comprises said storage unit.

8. The packet communication system of claim 7, wherein said origin-of-movement communication unit comprises an origin-of-movement movement control unit which stops said virtual machine unit, transmits a packet transmission switching instruction for instructing to switch a transmission destination of said packet destined for said virtual machine unit into said movement-destination communication unit to said switch unit, transmits said packet destined for said virtual machine unit received after stop of said virtual machine unit to said movement-destination communication unit, moves said virtual machine unit to said movement-destination communication unit, transmits said packet destined for said virtual machine unit received until said virtual machine unit moves to said movement-destination communication unit and restarts execution to said movement-destination communication unit, receives an acknowledgement of said packet transmission switching instruction from said switch unit, and transmits a packet transmission completion notice to said movement-destination communication unit.

9. A switch, comprising:
a storage unit which stores a packet destined for a virtual machine unit while said virtual machine unit moves from an origin-of-movement communication unit comprising said virtual machine to movement-destination communication unit which is a movement destination of said virtual machine unit; and
a transfer control unit which transfers said stored packet to said movement-destination communication unit.

10. The switch of claim 9, further comprising:
a transfer control unit which receives a transmission stopping instruction of said packet destined for said virtual machine unit from said origin-of-movement communication unit and transfers said stored packet to said virtual machine unit upon receiving a packet transmission restarting instruction destined for said virtual machine unit.

11. The switch of claim 10, wherein said storage unit stores said packet destined for said virtual machine until said virtual machine which moves to said movement-destination communication unit restarts and said transfer control unit receives said packet transmission restarting instruction destined for said moved virtual machine unit after said transfer control unit receives said packet transmission stopping instruction destined for said virtual machine unit from said origin-of-movement communication control unit.

12. A packet communication device, comprising:
a virtual machine unit;
a storage unit which stores a packet destined for said virtual machine unit while said virtual machine unit moves from its own communication device to another communication device which is a movement destination of said virtual machine unit; and
an origin-of-movement movement control unit which transfers said packet stored in said storage unit to said virtual machine unit.

13. The packet communication device of claim 12, wherein said origin-of-movement movement control unit stops said virtual machine unit and stores said packet destined for said virtual machine in said storage unit until said virtual machine unit restarts after movement after stop of said virtual machine.

14. A packet communication device, comprising:
a storage unit which stores a packet destined for a virtual machine unit while said virtual machine unit moves from other communication unit to its own communication device; and
a movement-destination movement control unit which transfers said packet stored in said storage unit to said virtual machine unit.

15. The packet communication device of claim 14, wherein said movement-destination movement control unit restarts said moved virtual machine and transfers said packet stored in said storage unit to said virtual machine on receiving a packet transfer completion notice from said other communication unit.

16. A packet communication method, comprising:
storing a packet destined for virtual machine unit while said virtual machine unit moves from first communication unit to second communication unit; and
transferring said stored packet to said second communication unit.

17. The packet communication method of claim 16, wherein said packet destined for said virtual machine unit is stored in a switch connected to said first communication unit and said second communication unit through a network.

18. The packet communication method of claim 16, wherein said packet destined for said virtual machine unit is stored in said first communication unit.

19. The packet communication method of claim 16, wherein said packet destined for said virtual machine unit is stored in said second communication unit.

20. A computer-readable storage medium having a packet communication program recorded therein for causing a computer to execute a process of storing a packet destined for virtual machine in storage unit which stores a packet while said virtual machine unit moves from first communication unit to second communication unit and a process of transferring said stored packet to said second communication unit.

21. A packet communication system, comprising:
virtual machine means;
origin-of-movement communication means;
movement-destination communication means; and
storage means for storing a packet destined for said virtual machine means while said virtual machine means moves from said origin-of-movement communication means to said movement-destination communication means and transferring said stored packet to said movement-destination communication means.

22. A switch, comprising:
storage means for storing a packet destined for a virtual machine means while said virtual machine means moves from an origin-of-movement communication means comprising said virtual machine to movement-destination communication means which is a movement destination of said virtual machine means;
transfer control means for transferring said stored packet to said movement-destination communication means.

23. A packet communication device, comprising:
virtual machine means;
storage means for storing a packet destined for said virtual machine means while said virtual machine means moves from its own communication device to another communication device which is a movement destination of said virtual machine means; and
origin-of-movement movement control means for transferring said packet stored in said storage means to said virtual machine means.

24. A packet communication device, comprising:
storage means for storing a packet destined for a virtual machine means while said virtual machine means moves from other communication means to its own communication device; and
movement-destination movement control means for transferring said packet stored in said storage means to said virtual machine means.
